(19) United States
(12) Patent Application Publication
(10) Pub. No.: US 2017/0139092 A1
(43) Pub. Date: May 18, 2017

(54) Polarizer, Quantum-Effect-Based Display Panel and Display Device

(71) Applicant: Shenzhen China Star Optoelectronics Technology Co., Ltd., Shenzhen, Guangdong (CN)

(72) Inventor: Xiangyang XU, Shenzhen, Guangdong (CN)

(73) Assignee: Shenzhen China Star Optoelectronics Technology Co., Ltd., Shenzhen, Guangdong (CN)

(21) Appl. No.: 14/768,286

(22) PCT Filed: May 6, 2015
(86) PCT No.: PCT/CN2015/078417

§ 371 Date: Aug. 17, 2015

(30) Foreign Application Priority Data
Apr. 23, 2015 (CN) 201510198343.8

(51) Int. Cl. G02B 5/30; G02F 1/13363; G02F 1/1335

(52) U.S. Cl. CPC G02B 5/305; G02B 5/3083; G02F 1/133528; G02F 1/13363; G02F 1/133514; Y10S 977/774; Y10S 977/952; B82Y 20/00

(57) ABSTRACT

A polarizer includes an optical retardation plate and a stack of a first adhesive layer, a polarizing layer, a third adhesive layer and a quantum effect layer in order on the optical retardation plate. The present invention also proposes a display panel and display device. Through the quantum effect layer in the polarizer, any RGB linear polarization light running through the polarizer will be modulated to RGB natural light with a narrower frequency spectrum. This expends the color gamut of displays, lowers power consumption, and can reduce the thickness of display panel, thus enabling a thinner design of display devices.

### BACKGROUND OF THE INVENTION

1. Field of the Invention

The present invention relates to a display technology field, more specifically to a polarizer as well as a quantum-effect-based display panel and a display device.

2. The Related Arts

A quantum dot (QD) is quasi-zero-dimensional nanometer material, constructed by a small amount of atoms. The movement of its interior electrons is confined in all directions, and therefore its quantum confinement effect is particularly obvious. Because quantum confinement effect results in a discontinuous electron energy level structure resembling that of an atom, a quantum dot is also called an “artificial atom.”

Quantum dots, also called nanocrystals, are nanometer particles formed by the II to VI or the III to V atom families. A quantum dot, such as a colloidal semiconductor nanocrystal, can be as small as 2 to 10 nanometers, corresponding to a diameter of 10 to 50 atoms. Because of the quantum confinement effect, quantum dots have a discontinuous energy level structure carrying the characteristics of a molecule, and can produce fluorescence once excited. Based on the quantum confinement effect, quantum dots have a great application promise in solar energy batteries, light-emitting elements, optical biological markers, etc.

Currently, there are already many ways to produce quantum dots and relative display products. A quantum dot entity may contain 100 to 100,000 quantum dots.

A QD television is a television whose LCD panel is adhered to a film of the quantum dot technology, or a television whose backlight module of its LCD panel is produced by the quantum dot technology. A QD panel has a production cost higher by 20% than that of a normal LCD or LED television, but a dramatic improvement in brightness and color reproduction. Before QLED televisions, which have an even better contrast and reaction speed, finally turn mainstream, QD televisions may very well become the star of the coming generation.

However, the present application of this kind of quantum dot fin is mainly in the form of an independent layer in a display device, and thus increases the number of layers and is unfavorable to make the device thinner.

### SUMMARY OF THE INVENTION

In view of the weakness of present technology, the present invention provides a polarizer whose light emitted is closer to natural light, as well as a display panel and a display device based on quantum effect.

According to the present invention, a polarizer comprises an optical retardation plate and a stack of a first adhesive layer, a polarizing layer, a third adhesive layer and a quantum effect layer in order on the optical retardation plate.

Furthermore, the first adhesive layer is made of a polyvinyl alcohol (PVA) material.

Furthermore, the optical retardation plate is a quarter wave plate made of a polycarbonate (PC) material or a cyclo olefin polymers (COP) material.

Furthermore, the polarizer further comprises a second adhesive layer disposed on a bottom surface of the optical retardation plate.

Furthermore, the second adhesive layer is a pressure sensitive adhesive.

Furthermore, the pressure sensitive adhesive is a compound of acrylate polymers, isocyanates vulcanizing agent and silicon coupling agent.

Furthermore, the polarizing layer is a stack of a first triacetate cellulose (TAC) layer disposed on an upper surface of the first adhesive layer, a polyvinyl alcohol (PVA) layer, and a second TAC layer disposed on a bottom surface of the third adhesive layer.

According to the present invention, a quantum-effect-based display panel comprises a bottom polarizer, a glass substrate, a color filter film substrate and a polarizer in order. The polarizer comprises an optical retardation plate and a stack of a first adhesive layer, a polarizing layer, a third adhesive layer and a quantum effect layer in order on the optical retardation plate.

According to the present invention, a display device comprises a backlight module and a display panel as mentioned above. The display panel disposed on an upper surface of the backlight module.

The present invention utilizes the quantum effect layer in a polarizer. Any RGB linear polarization light running through the polarizer will be modulated to RGB natural light with a narrower frequency spectrum. This expends the color gamut of displays, lowers power consumption, and can reduce the thickness of display panel, thus enabling a thinner design of display devices.

### BRIEF DESCRIPTION OF THE DRAWINGS

FIG. 1 shows a schematic diagram of a polarizer according to a preferred embodiment of the present invention.

FIG. 2 shows a schematic diagram of a display device using the present inventive polarizer according to a preferred embodiment of the present invention.

### DETAILED DESCRIPTION OF THE PREFERRED EMBODIMENTS

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

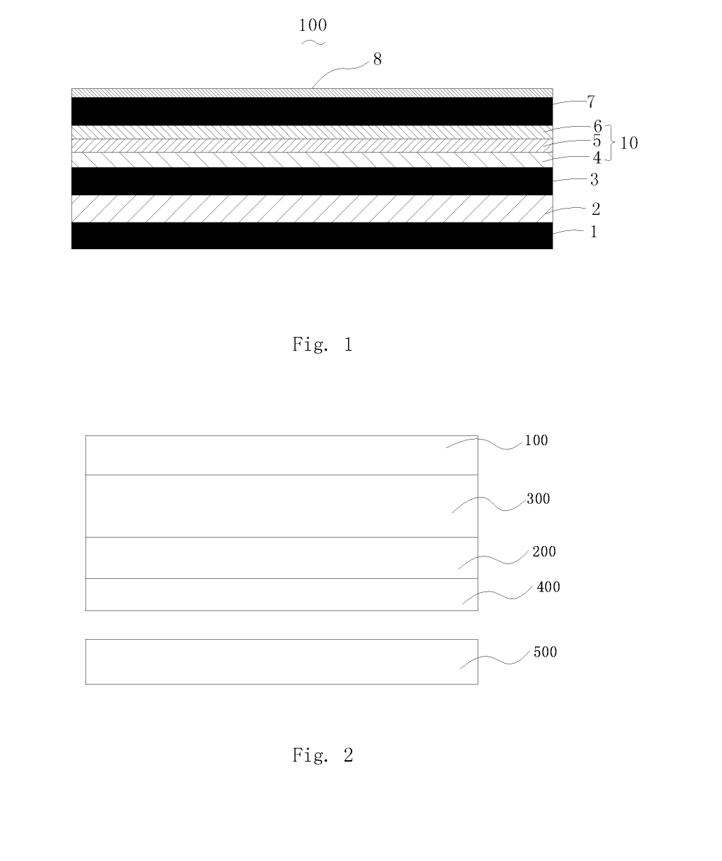

Please refer to FIG. 1 showing a schematic diagram of a polarizer according to a preferred embodiment of the present invention. A polarizer 100 comprises an optical retardation plate 2 and a stack of a first adhesive layer 3, a polarizing layer 10, a third adhesive layer 7 and a quantum effect layer 8 in order on the optical retardation plate 2.

The quantum effect layer 8 is constituted by red, green and blue (RGB) quantum dot materials which are excited by linear polarization light through a liquid crystal display (LCD) panel to radiate brighter and higher purity natural light. Therefore, a display using the quantum dots has advantages of wider color gamut and lower power consumption. In contrast to a conventional LCD device using white light emitting diodes (LEDs) as a backlight source, the present inventive polarizer makes the RGB colors more even and closer to natural light. Compared with an LCD device using an LED backlight module with a 73% NTSC (National Television Standards Committee) color reproduction and a 95% S-RGB color reproduction, the present inventive polarizer using the quantum effect layer 8 can upgrade to be over 100% or close to 100% color reproduction.

Preferably, the first adhesive layer 3 is made of a polyvinyl alcohol (PVA) material. The optical retardation plate 2 is a quarter wave plate made of a polycarbonate (PC) material or a cyclo olefin polymers (COP) material.

For assembling the polarizer, the polarizer further comprises a second adhesive layer 1 disposed on a bottom surface of the optical retardation plate 2. The second adhesive layer 1 and the third adhesive layer 3 are a pressure sensitive adhesive.

The pressure sensitive adhesive is a compound of acrylate polymers, isocyanates vulcanizing agent and silicon coupling agent.

Specifically, the polarizing layer 10 is a stack of a first triacetate cellulose (TAC) layer 4, a polyvinyl alcohol (PVA) layer 5, and a second TAC layer 6 in order. The first TAC layer 4 is disposed on an upper surface of the first adhesive layer 3, and the second TAC layer 6 is disposed on a bottom surface of the third adhesive layer 7.

Please refer to FIG. 2 showing a display device using the present inventive polarizer as an upper polarizer according to a preferred embodiment of the present invention. The display device comprises a backlight module 500 and a display panel (not shown) disposed on an upper surface of the backlight module 500. The quantum-effect-based display panel comprises a bottom polarizer 400, a glass substrate 200, a color filter film substrate 300 and a polarizer 100 in order. The bottom polarizer 400 is disposed opposite to the backlight module 500.

The present inventive polarizer is used as an upper polarizer in the display panel. Through the quantum effect layer in the polarizer, any RGB linear polarization light running through the polarizer will be modulated to RGB natural light with a narrower frequency spectrum. This expends the color gamut of displays, lowers power consumption, and can reduce the thickness of display panel, thus enabling a thinner design of display devices.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A polarizer, comprising an optical retardation plate and a stack of a first adhesive layer, a polarizing layer, a third adhesive layer and a quantum effect layer in order on the optical retardation plate.

2. The polarizer according to claim 1, wherein the first adhesive layer is made of a polyvinyl alcohol (PVA) material.

3. The polarizer according to claim 1, wherein the optical retardation plate is a quarter wave plate made of a polycarbonate (PC) material or a cyclo olefin polymers (COP) material.

4. The polarizer according to claim 1, further comprising a second adhesive layer disposed on a bottom surface of the optical retardation plate.

5. The polarizer according to claim 4, wherein the second adhesive layer is a pressure sensitive adhesive.

6. The polarizer according to claim 5, wherein the pressure sensitive adhesive is a compound of acrylate polymers, isocyanates vulcanizing agent and silicon coupling agent.

7. The polarizer according to claim 1, wherein the polarizing layer is a stack of a first triacetate cellulose (TAC) layer disposed on an upper surface of the first adhesive layer, a polyvinyl alcohol (PVA) layer, and a second TAC layer disposed on a bottom surface of the third adhesive layer.

8. The polarizer according to claim 2, wherein the polarizing layer is a stack of a first triacetate cellulose (TAC) layer disposed on an upper surface of the first adhesive layer, a polyvinyl alcohol (PVA) layer, and a second TAC layer disposed on a bottom surface of the third adhesive layer.

9. The polarizer according to claim 3, wherein the polarizing layer is a stack of a first triacetate cellulose (TAC) layer disposed on an upper surface of the first adhesive layer, a polyvinyl alcohol (PVA) layer, and a second TAC layer disposed on a bottom surface of the third adhesive layer.

10. The polarizer according to claim 4, wherein the polarizing layer is a stack of a first triacetate cellulose (TAC) layer disposed on an upper surface of the first adhesive layer, a polyvinyl alcohol (PVA) layer, and a second TAC layer disposed on a bottom surface of the third adhesive layer.

11. The polarizer according to claim 5, wherein the polarizing layer is a stack of a first triacetate cellulose (TAC) layer disposed on an upper surface of the first adhesive layer, a polyvinyl alcohol (PVA) layer, and a second TAC layer disposed on a bottom surface of the third adhesive layer.

12. The polarizer according to claim 6, wherein the polarizing layer is a stack of a first triacetate cellulose (TAC) layer disposed on an upper surface of the first adhesive layer, a polyvinyl alcohol (PVA) layer, and a second TAC layer disposed on a bottom surface of the third adhesive layer.

13. A quantum-effect-based display panel, comprising a bottom polarizer, a glass substrate, a color filter film substrate and a polarizer in order,
wherein the polarizer comprises an optical retardation plate and a stack of a first adhesive layer, a polarizing layer, a third adhesive layer and a quantum effect layer in order on the optical retardation plate.

14. The display panel according to claim 13, wherein the polarizer further comprises a second adhesive layer disposed on a bottom surface of the optical retardation plate.

15. The display panel according to claim 14, wherein the second adhesive layer is a pressure sensitive adhesive.

16. The display panel according to claim 13, wherein the polarizing layer is a stack of a first triacetate cellulose (TAC) layer disposed on an upper surface of the first adhesive layer, a polyvinyl alcohol (PVA) layer, and a second TAC layer disposed on a bottom surface of the third adhesive layer.

17. A display device, comprising a backlight module and a display panel thereon, the display panel comprising a bottom polarizer, a glass substrate, a color filter film substrate and a polarizer in order,
wherein the polarizer comprises an optical retardation plate and a stack of a first adhesive layer, a polarizing layer, a third adhesive layer and a quantum effect layer in order on the optical retardation plate.

18. The display device according to claim 17, wherein the polarizer further comprises a second adhesive layer disposed on a bottom surface of the optical retardation plate.

19. The display device according to claim 18, wherein the second adhesive layer is a pressure sensitive adhesive.

20. The display device according to claim 17, wherein the polarizing layer is a stack of a first triacetate cellulose (TAC) layer disposed on an upper surface of the first adhesive layer, a polyvinyl alcohol (PVA) layer, and a second TAC layer disposed on a bottom surface of the third adhesive layer.
